(19) United States
(12) Patent Application Publication
(10) Pub. No.: US 2007/0227983 A1
(43) Pub. Date: Oct. 4, 2007

(54) Suction side and pressure side fluid filter with internal by-pass

(76) Inventors: Theodore M. Bryson, Fayetteville, NC (US); Ibrahim Khalil, Barrington, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/394,182

(22) Filed: Mar. 31, 2006

(51) Int. Cl. B01D 37/00

(52) U.S. Cl. 210/767; 210/434

(57) ABSTRACT

A fluid filter includes a filtered flow and a bypass flow. In particular, a fluid filter insert includes a first end cap, a second end cap, a screen disposed between the first and the second end caps, and a filter media surrounding the screen. Further, a method of filtering a fluid includes passing a first portion of the fluid through a fluid filter inlet, passing a second portion of the fluid through a filter media, and passing the first and the second portions through a filter outlet. In addition, a fluid filter includes a bypass inlet, a filter media inlet coaxial with the bypass inlet, an outlet axially spaced from the bypass inlet, and a housing surrounding the bypass inlet, the filter media inlet and the outlet. Further, the fluid filter provides that the bypass inlet is dimensioned to permit a predetermined amount of flow.

### FIELD OF THE INVENTION

The present invention relates generally to automotive fluid circuits. More particularly, the present invention relates to an in-line fluid filter for automotive fluid circuits.

### BACKGROUND OF THE INVENTION

An automobile's engine and transmission can create a great deal of heat. In particular, heat can degrade the engine or transmission lubricant. Such lubricant degradation may have negative consequences, potentially causing catastrophic damage to the engine or transmission. Other types of machinery also require heat removal.

Therefore, cooling systems have been provided to remove excessive heat created by engines, transmissions or machinery. Specifically, coolants may be passed through a heat exchanger to remove this heat. A heat exchanger for an engine is commonly referred to as a radiator. A heat exchanger for a transmission is commonly referred to as an oil cooler.

Coolants are circulated through the radiator or oil cooler and may collect debris as they are circulated. As such, these coolants require filtration. However, excessive filtration may retard the flow of the coolant through the heat exchanger, causing excessive heat and overheating the engine or transmission. To alleviate this challenge, these coolant filters have sometimes been provided with bypass valves. However, these bypass valves may function improperly. At times, the valves are left open, preventing the coolant from being filtered. At other times, the valves remain closed, cutting off the coolant from circulating, thus over-heating the engine or transmission. Further, bypass valves may be large and cumbersome to place in the coolant line and increase cost and complications during installation. They may also need to be replaced often, leading to increased cost and time spent on replacements and repair.

Accordingly, it is desirable to provide an apparatus and method to filter coolants, while ensuring that the coolant adequately flows through the heat exchanger. Moreover, it is desirable to provide an apparatus and method to filter coolants inline, in an inexpensive and efficient manner.

### SUMMARY OF THE INVENTION

The foregoing needs are met, to a great extent, by the present invention, wherein in one aspect an apparatus is provided that in some embodiments filters fluid while ensuring adequate fluid flow to a heat exchanger, transmission, engine or other machinery. In particular, in some embodiments, the fluid filter provides that a portion of the fluid is filtered while another portion of the fluid bypasses the filter.

In accordance with one embodiment a fluid filter insert includes a first end cap, a second end cap, a screen disposed between the first and the second end caps, and a filter media surrounding the screen. Further, the fluid filter insert provides that the first end cap, the second end cap, the screen and the filter media are surrounded by a filter housing having a first end and a second end wherein the housing includes a housing inlet at the first end and a housing outlet at the second end. In addition, the housing inlet is axially spaced apart from the first end cap of the filter insert.

In accordance with another embodiment, a method of filtering a fluid includes passing a first portion of the fluid through a fluid filter inlet, passing a second portion of the fluid through a filter media, and passing the first and the second portions through a filter outlet. Further, the method provides that the filter media, the screen and the filter inlet and the filter outlet are placed in a filter housing wherein the filter housing includes a first end having a housing inlet and a second end having a housing outlet. In addition, the method includes the step of passing the first and second portions of the fluid through the housing inlet and the housing outlet wherein the filter inlet and the filter outlet comprise a first end cap having a first orifice and a second end cap having a second orifice, respectively.

In accordance with yet another embodiment of the present invention, a system for filtering fluid includes means for passing a first portion of the fluid through a fluid filter inlet, means for passing a second portion of the fluid through a filter media, and means for passing the first and the second portions through a filter outlet. Further, the system provides that the filter inlet and the filter outlet comprise a first end cap having a first orifice and a second end cap having a second orifice, respectively.

In accordance with still another embodiment of the present invention, a fluid filter includes a bypass inlet, a filter media inlet coaxial with the bypass inlet, an outlet axially spaced from the bypass inlet, and a housing surrounding the bypass inlet, the filter media inlet and the outlet. Further, the fluid filter provides that the bypass inlet is dimensioned to permit a predetermined amount of flow.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic view of a fluid filter in use in an automobile cooling system.

FIG. 2 is a perspective view illustrating the fluid filter according to an embodiment of the invention.

FIG. 3 is an exploded view of the fluid filter according to an embodiment of the invention.

### DETAILED DESCRIPTION

The invention will now be described with reference to the drawing figures, in which like reference numerals refer to like parts throughout. An embodiment in accordance with the present invention provides a fluid filter, particularly a coolant filter, that ensures adequate fluid flow to a heat exchanger. The filter may be used inline in an application. Further, it may be used on the pressure side or return side of an application. The filter is of simple construction and facilitates simple installation and fewer repairs or complications during its operation.

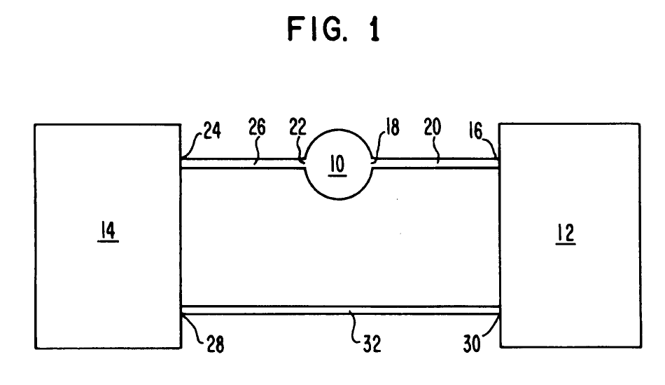

An embodiment of the present inventive apparatus is illustrated in FIG. 1. Specifically, FIG. 1 is a schematic view of a fluid filter 10 in use in an automobile cooling system. The filter 10 is placed in line with a transmission 12 and a heat exchanger 14. The heat exchanger 14 may be a cooler or a radiator. Line 20 allows filter 10 to be in fluid communication with transmission 12, with a transmission outlet 16 and a filter inlet 18. Line 26 allows the heat exchanger 14 to be in fluid communication with the filter 10, with a filter outlet 22 and a heat exchanger inlet 24. Lastly, the heat exchanger 14 and transmission 12 are in fluid communication through line 32, with a heat exchanger outlet 28 and a transmission inlet 30.

Lines 20, 26 and 32 may be any type of hose or conduit that permits fluid flow. Although in this case, a transmission 12 is shown, any type of machinery may be used. In particular, machines requiring fluid filtration may be used, such as an engine for example. Also, although an automotive system is shown, to illustrate one particular application that may utilize the filter of the present invention, the filter of the present invention may be utilized with any system or application, requiring fluid filtration. For example, a power steering application may use the filter 10 of this invention. Further, the filter 10 may be placed on the pressure side or return side of any system.

In the illustrated schematic diagram of FIG. 1, fluid constantly circulates between the transmission 12 and heat exchanger 14, cooling the fluid. The fluid can be any type of fluid requiring filtration, for example, transmission fluid, engine oil, power steering fluid, etc. In this instance, the fluid exits the transmission 12 at the transmission outlet 16 and enters the filter 10 at the filter inlet 18. There, the fluid is filtered, as will be described in further detail below.

Thereafter, the fluid exits the filter through the filter outlet 22 and enters the heat exchanger 14 through the heat exchanger inlet 24. While in the heat exchanger 14, the fluid is cooled as necessary and exits the heat exchanger 14 at the heat exchanger outlet 28. Finally, the fluid re-enters the transmission 12 via the transmission inlet 30 completing one circuit. Although, FIG. 1 shows a simple schematic representation of the filter 10 in use, the filter 10 may be installed in a variety of systems, with great complexity, not illustrated in this schematic view.

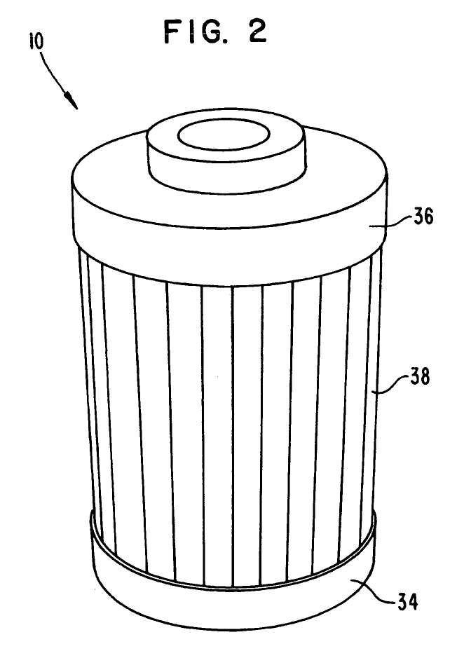

FIG. 2 is a perspective view illustrating the fluid filter 10 according to an embodiment of the invention. The filter 10 is shown having a first end cap 34, a second end cap 36 and a filter element 38. Specifically, the first end cap 34 may be a seat configured to hold a first end of the filter element 38. Likewise, the second end cap 36 may be a seat configured to hold a second end of the filter element 38. The first and second end caps 34 and 36, respectively, may be made of any suitable material, for example, a metal.

The filter element 38 may be any type of media or element capable of filtering fluid. In addition, the filter element 38 may be a fibrous media. In particular, the fibrous media may be pleated. The pleats provide greater surface area for filtration than non-pleated media. Further, the greater surface area may be placed in a smaller space.

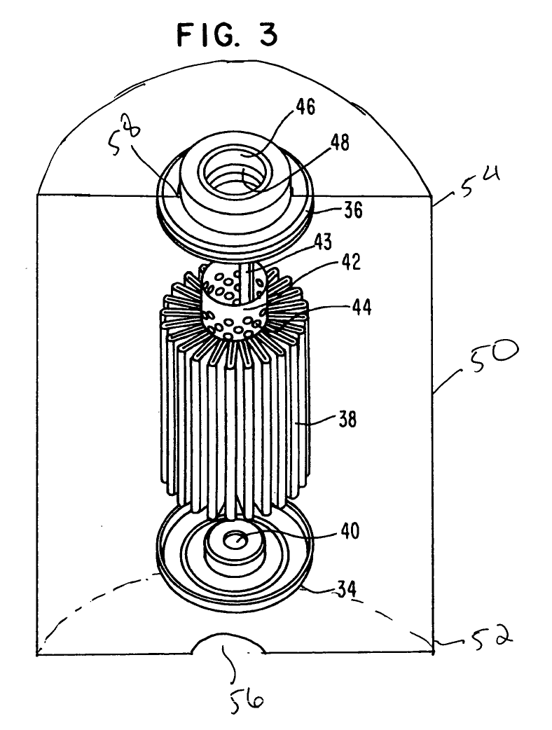

FIG. 3 is an exploded view of the fluid filter 10 according to an embodiment of the invention. Here, the first end cap 34 has a filter inlet 40. The filter element 38 surrounds a screen 42 having apertures 44 spaced throughout the screen 42. The second end cap 36 has a filter outlet 46. The filter outlet 46 may be fitted with a gasket 48.

The filter inlet 40 and outlet 46 may be any kind of opening or orifice. The screen 42 may be cylindrical and hollow in nature. Hollow area 43, created by the cylinder, serves as a bypass filter, as will be fully described below. The screen 42 may be formed of any suitable material. Preferably, the screen 42 is made of metal. The screen 42 provides structural integrity and support for the filter element 38. The filter element 38 is shown here in its pleated form, surrounding the screen 42.

The filter 10 may be placed in its entirety in a fluid filter housing 50. The filter housing 50 has a first end 52 and a second end 54. At the first end 52, the filter housing 50 has a housing inlet 56. The housing inlet 56 is spaced apart from filter inlet 40 to permit fluid to proceed around the filter 10 and enter the filter media 38. However, at the second end 54, the filter housing outlet 58 may couple with the filter outlet 46 such that the filtered flow and bypass flow may exit the filter outlet 46 and the filter housing outlet 58 simultaneously.

In operation, fluid enters the fluid filter housing 50 through the housing inlet 56. Part of the fluid is directed around the first end cap 34 of the filter 10 and enters the filter element 38 and is adequately cleaned. The filter element 38 may be configured to provide as much filtration as desired. For instance, the filter element 38 may be as dense or as sparse as desired, to achieve the level of filtration required. The filtered fluid then enters the hollow area 43 created by the screen 42 through apertures 44 and exits the filter 10 at the filter outlet 46. The apertures 44 themselves act as a secondary form of filtration, catching any particles that may not have been trapped by the filter element 38.

The remainder of the fluid enters the filter inlet 40 and proceeds through the hollow space 43 created by the screen 42 and exits the filter 10 directly at the filter outlet 46. As previously mentioned, both the filtered flow and the bypass flow exit the filter outlet 46 and the housing outlet 58 simultaneously. Thus, the remainder of the fluid is not filtered, allowing the fluid to bypass the filter element 38. This provides that there is always some fluid reaching the heat exchanger 14 or the transmission 12.

The portion of the fluid that is filtered may be between 10 and 40 percent of the total fluid, leaving between 90 and 60 percent, respectively, of the fluid unfiltered. The preferred percentage is to filter 30% of the fluid, leaving 70% of the fluid to bypass the filter element 38. The fluid inlet 40 may be designed to accommodate the percentage of fluid to be filtered. For example, if the size of the filter inlet 40 is very small, then more of the fluid would be directed around the first end cap 34, enter the filter media 38 and be filtered, allowing less fluid to enter the hollow area 43 and exit the filter 10, bypassing the filter media 38 altogether.

Correspondingly, if the size of the filter inlet 40 was large, more of the fluid would enter the hollow area 43 and proceed directly to the filter outlet 46 and exit the filter 10, bypassing the filter media 38 altogether. This in turn, directs less fluid around the first end cap 34, to be filtered by filter element 38. In this manner, the amount of fluid filtration can be controlled.

In addition, allowing only some of the fluid to be filtered ensures that fluid communication always occurs in the application being served by the filter 10. For instance, in the example illustrated by FIG. 1, allowing some fluid to bypass the filter element 38 ensures that there will be some fluid circulated between the heat exchanger 14 and the transmission 12 at all times. Other filters have been known to filter more or less of the fluid than originally intended. For instance, those filters with conventional bypass valves have been known to function improperly. This may leave less fluid to circulate, potentially causing catastrophic failure of the entire system. Correspondingly, less fluid may be filtered, allowing more debris and impurities to enter the system, also potentially causing failure of the system.

In addition to ensuring adequate fluid flow to the system at all times, the partial flow through the filter media 38 extends filter life. Because all of the flow does not proceed through the filter element 38, it does not get clogged with debris and impurities as easily and will not wear as easily. In such a manner, the life of the filter element 38 will be extended and this will result in fewer replacements of the filter 10. Fewer replacements lead to less cost and greater efficiency.

Further, the partial flow through the filter element 38 allows the filter 10 to be placed in a higher pressure application than would otherwise be possible with a conventional filter. Because only a portion of the fluid enters the filter element 38, the filter can be placed in a higher pressure application than a filter where all of the fluid passes through the filter media.

Moreover, the filter inlet 40 size can also be configured based on the pressure requirements of the application. For instance, if it is desired that 30% of the total flow be filtered through the filter element 38, then the following procedure might be followed to determine the size of the filter inlet 40. A filter 10 with a solid first end cap 34, having no orifice or inlet, may be installed in a filter housing. Fluid may then be passed through the filter 10 and pressure and flow may be measured.

The pressure drop across the filter element 38 may then be measured at 30% of total system fluid flow. This pressure drop across the filter element 38 may then be used to determine the filter inlet 40 size that would yield equivalent pressure drop at 70% total fluid flow. Then the filter inlet 40 size may be introduced to the first end cap 34 in any suitable manner to achieve 30% filtered flow.

Although an example of the filter is shown using coolants, it will be appreciated that other fluids can be used. Also, although the filter is useful to the automotive industry it can also be used in other industries. In particular, the filter 10 may be used in heating and ventilation systems, or any system requiring fluid filtration.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A fluid filter insert, comprising:
a first end cap;
a second end cap;
a screen disposed between the first and the second end caps; and
a filter media surrounding the screen.

2. The fluid filter insert of claim 1, wherein the first end cap, the second end cap, the screen and the filter media are surrounded by a filter housing having a first end and a second end.

3. The fluid filter insert of claim 2, wherein the housing comprises a housing inlet at the first end and a housing outlet at the second end.

4. The fluid filter insert of claim 3, wherein the housing inlet is axially spaced apart from the first end cap.

5. The fluid filter insert of claim 1, wherein the screen contains an aperture.

6. The fluid filter insert of claim 1, wherein the filter media is fibrous.

7. The fluid filter insert of claim 1, wherein the first and the second end caps further comprise a first and a second orifice, respectively.

8. The fluid filter insert of claim 7, wherein the first orifice is dimensioned to permit a predetermined amount of flow.

9. A method of filtering a fluid, comprising:
passing a first portion of the fluid through a fluid filter inlet;
passing a second portion of the fluid through a filter media; and
passing the first and the second portions through a filter outlet.

10. The method of claim 9, wherein the filter media is a fibrous media.

11. The method of claim 9, wherein the filter media is disposed between the filter inlet and the filter outlet.

12. The method of claim 9, wherein the filter media surrounds a screen.

13. The method of claim 12, wherein the filter media, the screen and the filter inlet and the filter outlet are placed in a filter housing.

14. The method of claim 13, wherein the filter housing comprises a first end having a housing inlet and a second end having a housing outlet.

15. The method of claim 14, further comprising the step of passing the first and second portions of the fluid through the housing inlet and the housing outlet.

16. The method of claim 9, wherein the filter inlet and the filter outlet comprise a first end cap having a first orifice and a second end cap having a second orifice, respectively.

17. A system for filtering fluid, comprising:
means for passing a first portion of the fluid through a fluid filter inlet;
means for passing a second portion of the fluid through a filter media; and
means for passing the first and the second portions through a filter outlet.

18. The system of claim 17, wherein the filter inlet and the filter outlet comprise a first end cap having a first orifice and a second end cap having a second orifice, respectively.

19. The system of claim 17, wherein the filter media is disposed between the filter inlet and the filter outlet.

20. The system of claim 17, further comprising a means for housing said system.

21. A fluid filter, comprising:
a bypass inlet;
a filter media inlet coaxial with the bypass inlet;
an outlet axially spaced from the bypass inlet; and
a housing surrounding the bypass inlet, the filter media inlet and the outlet.

22. The fluid filter of claim 21, wherein the bypass inlet and the outlet are at either ends of a cylinder.

23. The fluid filter of claim 22, wherein the cylinder comprises a plurality of apertures.

24. The fluid filter of claim 22, further comprising a filter media surrounding the cylinder.

25. The fluid filter of claim 21, wherein the bypass inlet is dimensioned to permit a predetermined amount of flow.

26. The fluid filter of claim 21, wherein the housing comprises a housing inlet axially spaced apart from the bypass inlet.
